(19) United States
(12) Patent Application Publication
(10) Pub. No.: US 2011/0308659 A1
(43) Pub. Date: Dec. 22, 2011

(54) METHOD FOR MANUFACTURING A THERMALLY INSULATED CONDUIT PIPE

(75) Inventor: Alfred Oeschger, Zurich (CH)

(73) Assignee: BRUGG ROHR AG HOLDING, Brugg (CH)

(21) Appl. No.: 13/146,140

(22) PCT Filed: Jan. 27, 2010
(86) PCT No.: PCT/CH2010/000021

§ 371 Date: Sep. 6, 2011

(30) Foreign Application Priority Data
Jan. 29, 2009 (EP) 090012170

(51) Int. Cl. F16L 9/14; B29C 44/32

(52) U.S. Cl. 138/149; 264/45.9; 425/113

(57) ABSTRACT

A thermally insulated conduit pipe (22) is produced in that an inner pipe (2), onto which an outer pipe (13) has been extruded and which is enclosed by foam, is worked downstream of the extruder (12) with molding tools (16-21) in order to achieve deep undulation. This results in a conduit pipe having a small bending radius.

### BACKGROUND

The invention relates to a method for manufacturing a thermally insulated conduit pipe which comprises at least an inner pipe, arranged at a distance therefrom an undulated outer pipe made of plastic and a layer made of foamed plastic filling the space between the inner pipe and the outer pipe, wherein the inner pipe is first enclosed by foam and the outer pipe is extruded onto the inner pipe enclosed by foam. Furthermore, the invention relates to a thermally insulated, undulated conduit pipe as well as an installation for carrying out the method.

### PRIOR ART

A method according to the preamble of claim 1 is known from EP-A-0 897 788. This method has proven itself and leads to thermally insulated conduit pipes of high quality. Conduit pipes manufactured with the method are for example used in the local and district heating supply or in industrial applications. The undulation created according to EP-A-0 897 788 in the process of foam enclosure of the inner pipe or of the inner pipes allows small bending radii of the finished pipe, which are different depending on pipe dimensions and which allow an easy pipe laying. For example, a conduit pipe for the heat supply known as CALPEX® has in a dimensioning with an outer pipe of 162 mm a bending radius of 1.2 meters. There may exist applications for which an even smaller bending radius of the thermally insulated pipe is required. A method for forming thermally insulated plastic conduit pipes is known from DE-A 195 07 110, in case of which an outer plastic pipe of only 0.3 to 0.5 mm wall thickness is extruded coaxially to an inner pipe, wherein this outer pipe is pulled into the molds by vacuum by means of a mold chain arranged in vacuum, like in the case of a corrugator machine for the manufacturing of undulated plastic pipes. At the same time, a PE-foam containing propellant is extruded into the empty space between the outer thin pipe and the inner pipe, wherein the foam fills the empty space. By pulling-in a thin outer pipe into the molds by means of vacuum, only an undulation with a low depth can be reached. The manufacturing of a thermally insulated conduit pipe is known from WO-A 02/07948, in case of which an inner pipe is provided with an insulation layer onto which an outer pipe is overlaid. Solely the outer pipe is then provided with a rib structure by means of a rib structure maker. It is for example known from U.S. Pat. No. 5,522,718 that in the case of manufacturing simple undulated pipes mold halves are conveyed on a return section by means of grapplers and slides.

### DESCRIPTION OF THE INVENTION

The invention has the task of improving a thermally insulated conduit pipe and its manufacturing method.

This is reached with the method mentioned at the beginning by creating the undulated shape by means of molding tools, after completed extrusion of the outer pipe, on the inner pipe which is enclosed by foam.

It has been seen that in this way, in the case of the special compound consisting of inner pipe, foamed thermal insulation and outer pipe with the undulation valleys, an undulation which extends deep into the conduit pipe can be brought into the outer pipe and the thermal insulation, resulting in a higher bendability. The deep undulation is thereby pressed into the extruded thermally insulated conduit pipe. It extends deep inside the conduit pipe and therefore into the thermal insulation. This is contrary to the described methods with corrugator machines by using vacuum (or over-pressure) for creating the undulated shape, by means of which only a comparatively small depth of the undulation is reached.

The deep undulation by pressing-in is preferably done directly after the completed extrusion of the outer pipe, after which the conduit pipe has a temperature which allows the plastic deformation by the molding tools. It is thereby preferred that the extruded conduit pipe is tempered to a suitable temperature for this on the way to the deep undulation, for example by means of a spray bath with water. By this, the extruded conduit pipe has an optimum temperature for the pressing-in of the deep undulation when it gets to the tools provided for this. However, a later bringing-in of the deep undulation may also take place in a separate manufacturing step, for which the conduit pipe is brought to a temperature allowing the pressing-in of the undulation by heating means.

A first undulation may be created by usual means already for the foamed thermal insulation, as described in EP-A-0 897 788, wherein the deep undulation is molded around and deepens this first undulation after the extrusion according to the present invention. One may also provide an evenly foamed pipe extruded with an even outer pipe with the pressed-in undulation according to the present invention. The procedure according to the first option, in case of which the molding with the deep undulation is done for an already undulated conduit pipe after the extrusion, is preferred because the undulation normally yields a higher material thickness in the undulation valleys of the outer pipe in the case of foaming and subsequent extrusion of the outer pipe onto this first undulation. It is then available for the deep second undulation by means of the molding tools after the extruder, such that even in the case of a deeper undulation no imperfections arise in the outer pipe. Thereby, a detection of the first undulation, particularly prior to the extruder, and an adapted positioning of the molding tools for the deep undulation may take place.

It is preferred that the undulation depth is greater or equal to 4 mm and it is therefore at least 33% higher that in case of the mentioned CALPEX® conduit pipe which is manufactured according to the prior art. An undulation depth of 4 to 10 mm is particularly preferred. According to the invention it is possible to create substantially U-shaped undulation valleys which are separated from each other particularly by means of even upper side sections. This shaping results in a good material distribution of the outer pipe material during the molding after the extrusion. In a preferred embodiment, the molds used for the deep undulation are cooled, particularly by providing water cooling. In order to detach the molds for the deep undulation from the conduit pipe it may be provided that the molds have channels allowing the blowing-in of air for supporting the detaching.

The task is further solved by a conduit pipe according to the invention.

### SHORT DESCRIPTION OF THE DRAWINGS

In the following, examples of the invention are explained by means of the drawings. Thereby it is shown in

FIG. 1 schematically an installation for carrying out the method;

FIG. 2 schematically the creation of the undulated final shape; and

FIG. 3 a partial section view of a preferred embodiment of the conduit pipe.

### WAYS OF CARRYING OUT THE INVENTION

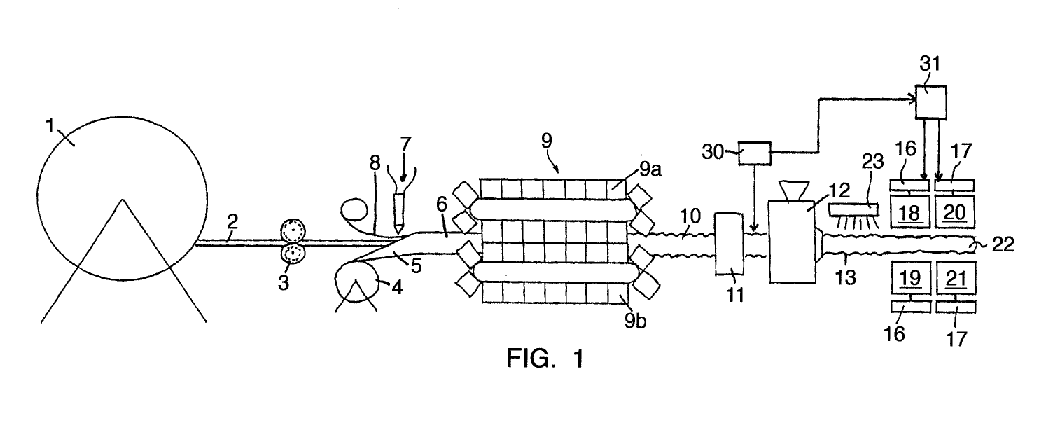

FIG. 1 shows the arrangement for manufacturing a thermally insulated conduit pipe known from EP-A-0 897 788, from the supply reel 1 to and with the extruder 12. Thereby, an inner pipe 2 is continually removed from the supply reel 1. The means for removing or conveying respectively in manufacturing direction are not shown because such means are known by the skilled person. The inner pipe may be a plastic pipe or also a metal pipe and it may be even or undulated. Particularly, an inner pipe 2 made of meshed polyethylene is used. The inner pipe 2 may be lead through a caliber roller pair 3, the rollers of which are actuated. The caliber roller pair 3 is preferably shifted in two mutually perpendicular directions transversally to the manufacturing direction or removal direction respectively.

A plastic foil 5, particularly a polyethylene foil, is removed from a supply spool 4 and shaped into a slotted tube with a glued or welded longitudinal seam around the inner pipe 2 concentrically to it. A foaming-up plastic mixture is brought into the still open slotted tube 6, particularly on a polyurethane basis or a polyethylene basis, for example by means of the nozzle 7. The closed slotted tube is inserted into a molding tool 9 which is formed by a plurality of molding halves 9a and 9b which form together a “traveling molder” for the inner pipe which is provided with the insulation layer under the foil 5.

The surfaces of the molding halves 9a and 9b facing the foil 5 or the slotted tube 6 respectively may have an undulated profile, inside of which the foil 5 is molded in due to the foaming pressure. In this case, which is shown in the figure, the pipe 10 coming out of the molding tool 9 has an undulated surface. The surfaces of the molding halves 9a and 9b facing the foil 5 may however also be even. The pipe 10 coming out of the molding tool 9 has in this case an even surface. In this case the molding tool 9 could also replaced by an idle hollow cylindrical shape.

The pipe 10 may afterwards travel through the x-ray installation 11 known from EP-A-0 897 788 by means of which the pipe 10 is continually checked for an exact centered position of the inner pipe.

In the next manufacturing step the outer pipe 13 made of plastic is extruded onto the pipe 10 by means of an extruder 12. For this, a vacuum causing the fitting of the outer pipe on the foamed pipe 10 is generated in a known way. In the case of the undulated pipe 10, the outer pipe 13, which can also be called an outer shell, fits to the undulation of the pipe. In case of the even pipe 10 the outer shell fits to the even pipe and becomes also even. Thereby, the outer shell glues to the plastic foil 5 because of its high temperature which was kept up by the extrusion.

Preferably, the deep undulation is brought into the extruded conduit pipe directly following the extrusion step in the manufacturing process of the conduit pipe, such that a continuous manufacturing results. The deep undulation takes place by pressing the undulation mold into the conduit pipe. This is done for example in such a way that the deep undulation is brought in according to the present invention by means of molding tools 16-21 at a distance from the extruder 12 which may for example be 3-4 m. This bringing-in is done in the pipe 10, which is still moldable because of the process heat due to the foaming and the extrusion, being provided with the outer pipe 13. The process heat of the preceding manufacturing steps of foaming and of extruding may be used or one may ensure by using heating means or cooling means respectively, that the pipe 10, 13 still has a temperature when entering the molding tools, which allows the pressing of the deep undulation into the conduit pipe. It is preferred to provide a spray bath 23 which brings the extruded conduit pipe to a temperature which is suitable for the deep undulation and which is then kept. The temperature depends on the plastic material of the conduit pipe and is therefore easy to determine for the skilled person or it is determinable by tries. The molding tools used to bring in the deep undulation may for example be endless molding tools traveling along, as they were shown for the molding tool 9 in case of the foaming or they may be other molding tools known to the skilled person. An example for other molding tools is explained in the following.

The pressing in of the deep undulation by means of molding tools may also be carried out in a separate manufacturing step, after the extruded conduit pipe has been cooled down and temporarily stored, such that a discontinuous manufacturing results. However, this subsequently requires a heating-up of the conduit pipe from the storage temperature to the temperature allowing the pressing-in of the deep undulation.

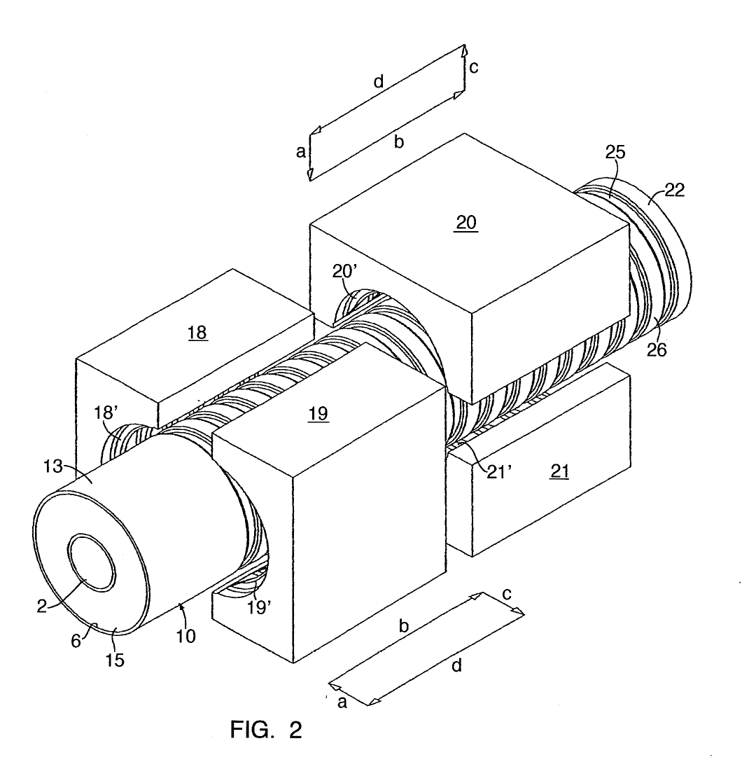

In the following, an example for the bringing in the deep undulation by means of molding tools is described according to FIGS. 1 and 2. A first pair of molding halves 18 and 19 of the molding tools has actuator means 16 which cause the movements of the molding halves 18 and 19 described in the following. The actuator means 17 are provided for the molding halves 20 and 21. The actuator means 16 and 17 may be pneumatic, hydraulic or/and electromotive or they may be differently formed. The actual form of these actuator means is a professional measure for the skilled person because of the motion requirements described in the following and will not be further described here. After leaving the molding halves 20 and 21, the conduit pipe is formed with the deep undulation. It may be lead through a cooling station not shown and then it may be removed by a belt-type capstan and winded on a drum.

FIG. 2 shows the molding tool halves 18-21 without the actuator means. The movements of the molding halves caused by these are shown by the arrows A-D. The pipe 10 with the inner pipe 2, the foamed plastic insulation 15 which has on its outer side the foil hose 6 and the outer pipe 13 extruded thereon is shown in the drawing as it came out of the extruder 12. In this case without undulation as even pipe. The molding halves 18 and 19 bring in the deep undulation into it from both sides of the pipe with their only partially shown molding parts 18′ and 19′, whereas the molding parts 20 and 21 bring in the deep undulation from the top and the bottom with their only partially shown molding parts 20′ and 21′. The molds are dimensioned in such a way that an equally distributed deep undulation around the conduit pipe 22 results. This is done such that the molding half 19 is actuated in the direction of the arrow a and the molding part 18 is actuated in the opposite direction of the arrow a, such that the molding halves close and the corresponding molding of the still hot and deformable pipe 10 is caused. The closing and closed molding halves 18 and 19 are driven in the direction of arrow b with the manufacturing speed of the pipe 10 coming out of the extruder. After the corresponding travel has been executed, which may for example be the case after 3 seconds to 5 seconds or more retention time of the pipe 10 in the mold, the molding halves 19 and 18 are driven apart at the end of the travel section b, wherein this requires a movement in the direction of arrow c for the molding half 19 and an opposite movement for the molding half 18. FIG. 2 shows this position of driving apart of the molding halves 18 and 19. By this, the side areas of the pipe 13 have been formed. Contrary to the view in the figure, the upper and the lower areas of the pipe 13 have not been molded yet, however this differs in the figure in order for the molding by means of the molding halves to be basically better viewable. The upper and lower forming is done by the molding halves 20 and 21, which are described in what follows. Starting from the shown position of the molding halves 18 and 19 a travel in the direction of the arrow d is carried out, wherein this is done with a higher speed than the manufacturing speed of the conduit pipe 22. Thereby, the molding halves 18 and 19 are driven so far in the direction d, that the still unformed side areas of the pipe are molded in the next closure in the direction of the arrow or in the opposite direction. It may be provided that thereby always the first undulation step of the mold in manufacturing direction engages exactly in the most recently molded undulation.

The molding tool with the molding halves 20 and 21 which form the undulation on the top and the bottom works the same way. A closure in the direction of the arrow a or in the opposite direction respectively is carried out, such that both molding halves 20 and 21 form the closed mold. After that the method is carried out in the direction of the arrow b for the same retention time as for the molding halves 18 and 19. After that the demolding in the direction of the arrow c or in the opposite direction respectively and the fast driving back of both molding halves in the direction of the arrow d is carried out. These movements are obviously done synchronized with the movements of the molding halves 18 and 19, such that all molding halves execute the shifting together in the direction of the arrows b or together the fast driving back in the direction of the arrows d.

Preferably, the molding halves are cooled, particularly by providing fluid channels in the molding halves, into which a cooling fluid (preferably water) is fed into the molding halves via a (not shown) supply port and may be drained off via a (not shown) drain port. Furthermore it is preferred that the molding halves are provided with air passages and a port for pressurized air, such that pressurized air can be blown into the molding space of the molding halves in order to support the demolding of the deep undulated pipe.

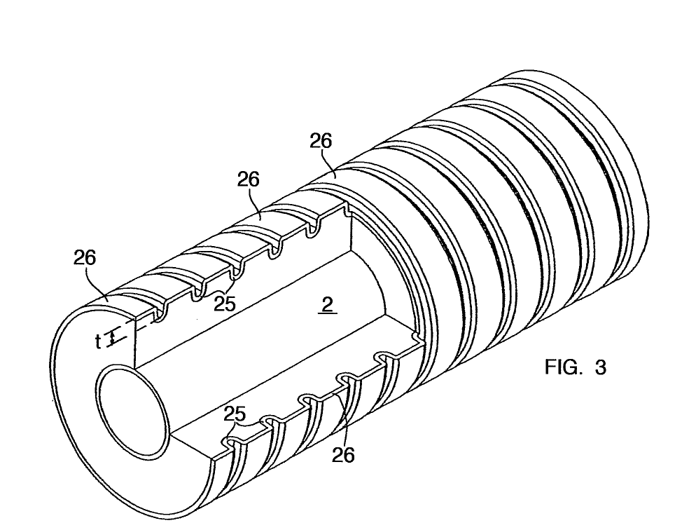

FIG. 3 shows a completely manufactured conduit pipe 22 which has been molded accordingly, wherein same reference numerals as used so far denote same parts. The deep undulation with the undulation valleys 25 and the upper sides 26 arranged therebetween is shown. The deep undulation extends thereby as shown deep inside the insulation layer of the conduit pipe. The shown molding is preferred, in case of which the undulation valleys 25 are substantially U-shaped and the upper sides 26 are substantially even. Other shapings are possible as well. The depth t of the undulation valley which can be seen in a section view of FIG. 3 is preferably of 4 mm or more, as seen from the upper side 26 of the conduit pipe. Particularly, a range of 4-10 mm is preferred. Such a deep undulation can be pressed into the conduit pipe by means of molding tools and leads to a very good bendability of the conduit pipe. This may be carried out in the previously described way. Thereby it is preferred that the pipe 10 has been undulated in the described known way before the extruder 12, such that the section of the pipe 13 shown in FIG. 2 left from the molding halves 18 and 19 would have an undulation which is however not as deep as the undulation created with the molding halves 18-21. The undulation valleys 25 are then preferably brought in where the undulation valleys have already been created by the molding tools 9.

It may preferably be made sure that the deep undulations are brought in each in an undulation valley of the previously undulated conduit pipe by providing a detection device which detects the existing undulation before the molding tools and controls the molding tools such that they execute the pressing-in of the deep undulation aligned to the previous undulation. This is shown in FIG. 1 as an example in such a way that a detection device 30 detects the undulation, in this example already the undulation of the foamed pipe 10 before the extruder. This may for example be done optically or by ultrasonic by determining the undulation valleys, for example by a distance measurement, or it may be done mechanically. The position of each of the undulation valleys (or alternatively or additionally of the undulation crest) may then be passed as input value to the controller 31 of the molding tools. It controls the actuator means 16, 17 of the molding tools in a way that the pressing-in of the deep undulation valleys is done by the molding tools exactly at the location of the undulation valleys of the pre-undulated conduit pipe 10.

In the claims:

1. Method for manufacturing a thermally insulated conduit pipe (22), which comprises at least an inner pipe (2), arranged at a distance thereto an undulated outer pipe (13) made of plastic and a layer (15) of foamed plastic filling the space between inner pipe and outer pipe, wherein firstly the inner pipe (2) is enclosed in foam and the outer pipe (13) is extruded onto the pipe (10) formed by the inner pipe enclosed in foam, characterized in that the undulated shape (25, 26) is created by means of molding tools (16-21) after a completed extrusion of the outer pipe onto the foam.

2. Method according to claim 1, characterized in that the undulated shape is pressed into the conduit pipe by the molding tools.

3. Method according to claim 1, characterized in that the undulated shape is created directly after the extrusion of the outer pipe (13).

4. Method according to claim 1, characterized in that the depth (t) of the undulation is equal or greater than 4 mm and particularly is of 4 to 10 mm.

5. Method according to claim 1 characterized in that the valley (25) of the undulation shape is substantially U-shaped.

6. Method according to claim 1, characterized in that the upper side (26) of the undulation shape between the valleys is substantially even.

7. Method according to claim 1, characterized in that the molding tools comprise molding halves (18-21) which travel along cyclically with the manufacturing speed of the conduit pipe (22) during the creation of the undulation shape and travel back in the opposite direction with a higher speed after the demolding.

8. Method according to claim 1, characterized in that a first undulation shape is formed during the enclosure in foam of the inner pipe (2), such that the outer pipe (13) extruded thereon has the first undulation shape, whereafter the deep undulation (25, 26) is created by means of the molding tools after the terminated extrusion of the outer pipe in such a way that the undulation valleys (25) of the deep undulation are created in the area of the undulation valleys of the first undulation shape created during the foaming.

9. Method according to claim 8, characterized in that the first undulation shape is detected by means of a detection device (30) and in that the bringing in of the second undulation shape onto the first undulation shape is aligned by means of a controlling means (31) which responds to an output signal of the detection device.

10. Method according to claim 1, characterized in that a tempering section is provided for the conduit pipe after the extrusion of the outer pipe (13), particularly of the type of a spray bath (23), whereafter the pressing of the deep undulation into the tempered conduit pipe is done.

11. Thermally insulated, undulated conduit pipe (22), particularly producible with the method according to claim 1, with at least an inner pipe (2), a foamed insulation layer (15) and an undulated outer pipe (13) made of plastic, characterized in that the depth (t) of the undulation is equal to or greater than 4 mm and particularly is of 4 to 10 mm.

12. Conduit pipe according to claim 10, characterized in that the valley (25) of the undulation shape has substantially a U-shaped cross section and the upper side (26) of the undulation shape is substantially even.

13. Installation for manufacturing a thermally insulated, undulated conduit pipe according to the method according to claim 1, wherein the installation comprises an installation (7, 9) for enclosing the at least one inner pipe with a thermally insulating plastic foam and an extruder (12) for applying an outer pipe onto the plastic foam, characterized in that a molding tool arrangement (16 to 21) is provided in transport direction of the conduit pipe at a distance from the extruder, by means of which the deep undulation can be pressed into the extruded conduit pipe.

14. Installation according to claim 13, characterized in that a tempering section is arranged between the extruder and the molding tool arrangement, which particularly comprises a spray bath (23).

15. Installation according to claim 13, characterized in that the molding tools of the molding tool arrangement are cooled.
